(19) United States
(12) Patent Application Publication
(10) Pub. No.: US 2009/0212136 A1
(43) Pub. Date: Aug. 27, 2009

(54) SOLENOID VALVE AND FUEL INJECTOR HAVING THE SAME

(75) Inventor: Chihiro WAKABAYASHI, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/328,253

(22) Filed: Dec. 4, 2008

(30) Foreign Application Priority Data
Feb. 22, 2008 (JP) 2008-041934

(51) Int. Cl. F02M 51/06; F16K 31/06

(52) U.S. Cl. 239/585.5; 251/129.15

(57) ABSTRACT

An armature and a valve member reciprocally slide in a slide hole of a valve body. The valve member seats on or lifts off from a valve seat to close or open a valve hole. One of the armature and the valve member includes an engaging concave surface. A connector is formed separately from the armature and the valve member, or is formed integrally with the other one of the armature and the valve member. The connector includes an engaging convex surface that is in contact with the engaging concave surface of the one of the armature and the valve member.

### CROSS REFERENCE TO RELATED APPLICATION

This application is based on and incorporates herein by reference Japanese Patent Application No. 2008-041934 filed on Feb. 22, 2008.

### BACKGROUND OF THE INVENTION

1. Field of the Invention

The present invention relates to a solenoid valve and a fuel injector having the solenoid valve.

2. Description of Related Art

Conventionally, a solenoid valve that is incorporated in a fuel injector is known (see JP2006-1 94237A).

This solenoid valve has a valve body, an armature, a valve seat and a valve member. A slide hole is formed in the valve body. The armature can reciprocally slide in the slide hole. A valve hole is formed on the valve seat. The valve member reciprocally moves in cooperation with the armature. While the armature reciprocally slides in the slide hole, the valve member seats on or lifts off the valve seat to close or open the valve hole.

In the fuel injector having this solenoid valve, a backpressure of a piston that is operationally linked with a nozzle needle is controlled by opening or closing the valve hole of the solenoid valve, to move the nozzle needle upward or downward. An injection hole is closed by moving the nozzle needle downward. The injection hole is opened by moving the nozzle needle upward to inject fuel out of the injection hole. Since it is required to control fuel injection with high accuracy, the solenoid valve must control the backpressure of the piston with high accuracy.

In this regard, a dimensional tolerance required between the armature and the valve body, which has the slide hole, and a dimensional tolerance required between the valve member and the valve hole, which has the valve seat, are satisfied. Then, an association between the armature and the valve member absorbs a sum of these dimensional tolerances. Specifically, the valve member is formed in a spherical shape to be rotatable with respect to the armature. The valve member has a flat portion that can seat on the valve seat to close the valve hole.

In the solenoid valve disclosed in JP2006-194237A, the flat portion of the valve member can be inclined with respect to the valve seat if the valve member and the valve hole become axially misaligned. This is because the backpressure that is applied through the valve hole eccentrically acts on the flat portion of the valve member and the valve member is rotatable with respect to the armature. If the flat portion of the valve member is inclined with respect to the valve seat, the backpressure, which is applied through the valve hole and acts on the flat portion of the valve member, is reduced, to weaken a valve-opening force for opening the valve hole. This causes a problem of delay of timings of fuel injections out of the injection hole.

Moreover, if the flat portion of the valve member is inclined with respect to the valve seat, only an edge of the flat portion of the valve member comes in contact with the valve seat. A contact pressure between the flat portion of the valve member and the valve seat when the flat portion of the valve member is inclined with respect to the valve seat is larger than that when the flat portion of the valve member is widely in contact with the valve seat. Thus, the flat portion of the valve member and the valve seat wear faster. Due to the wears of the flat portion of the valve member and the valve seat, a valve-closing operation to close the valve hole becomes defective, to destabilize backpressure control of the piston. Thus, fuel injection operation to inject fuel out of the injection hole of the fuel injector becomes unstable, and it becomes difficult to control the fuel injection operation with accuracy.

### SUMMARY OF THE INVENTION

The present invention is made in view of the above-mentioned problem. Thus, it is an objective of the present invention to provide a solenoid valve that prevents the flat portion of the valve member from being inclined with respect to the valve seat when the valve member and the valve hole are axially misaligned, while associating the armature and the valve member to be rotatable with respect to each other.

To achieve the objective of the present invention, there is provided a solenoid valve that has a valve body, an armature, a valve seat, a valve member and a connector. The valve body has a slide hole that axially extends through the valve body. The armature is installed in the slide hole and is reciprocally slidable along an inner circumferential surface of the slide hole. The valve seat has a valve hole therein. The valve member is installed in the slide hole and is reciprocally slidable along the inner circumferential surface of the slide hole to seat on or lift off from the valve seat to close or open the valve hole. One of the armature and the valve member includes an engaging concave surface. The connector is formed separately from the armature and the valve member or is formed integrally with the other one of the armature and the valve member. The connector includes an engaging convex surface that is in contact with the engaging concave surface of the one of the armature and the valve member.

### BRIEF DESCRIPTION OF THE DRAWINGS

The invention, together with additional objectives, features and advantages thereof will be best understood from the following description, the appended claims and the accompanying drawings in which:

FIG. 1 is a cross-sectional view showing a fuel injector that includes a solenoid valve according to one embodiment of the present invention;

FIG. 2 is an enlarged cross-sectional view showing the solenoid valve according to the one embodiment, which magnifies a section II in FIG. 1;

FIG. 3 is an enlarged cross-sectional view showing the solenoid valve according to the one embodiment, which magnifies a section III in FIG. 2;

FIG. 4 is an exploded cross-sectional view showing principal parts of the solenoid valve according to the one embodiment, which are shown in FIG. 3;

FIG. 5 is an exploded cross-sectional view showing principal parts of a solenoid valve according to a first modification of the one embodiment;

FIG. 6 is an exploded cross-sectional view showing principal parts of a solenoid valve according to a second modification of the one embodiment; and

FIG. 7 is an exploded cross-sectional view showing principal parts of a solenoid valve according to a third modification of the one embodiment.

### DETAILED DESCRIPTION OF PREFERRED EMBODIMENTS

Embodiments of the present invention will be described hereafter with reference to the accompanying drawings. The same reference numerals are assigned to the same or equivalent parts across the embodiments shown in the drawings.

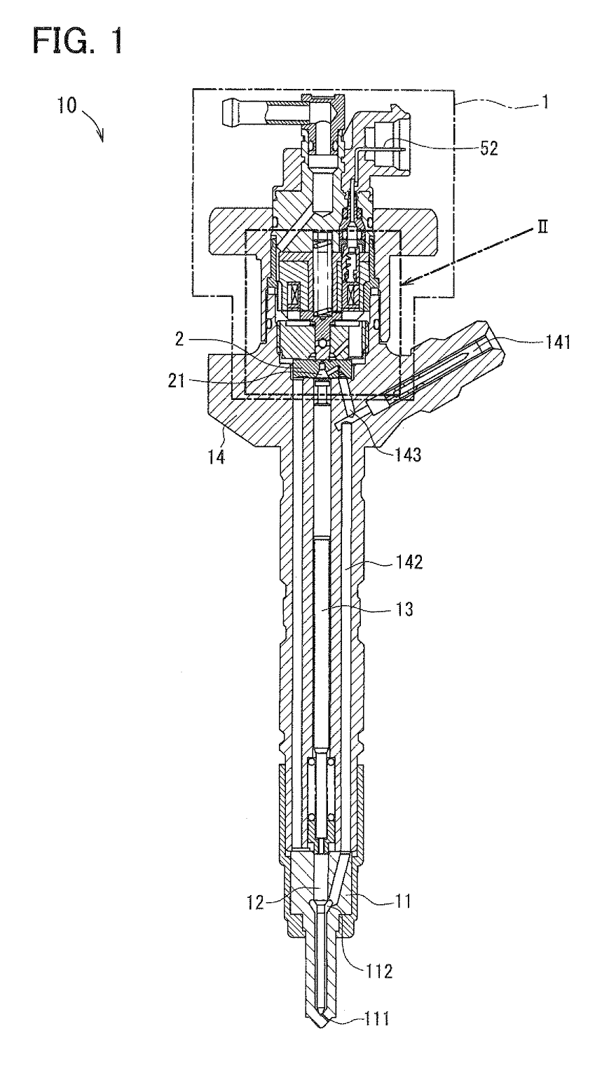

A fuel injector 10 shown in FIG. 1 is mounted on an engine. The fuel injector 10 is inserted in an engine head to inject fuel directly into each cylinder of the engine. The fuel injector 10 includes a solenoid valve 1, a nozzle body 11, a nozzle needle 12 and a piston 13. The solenoid valve 1 is for controlling backpressure in a backpressure control chamber 21. The nozzle body 11 has an injection hole 111 in its tip portion to inject the fuel therefrom. The nozzle needle 12 is for opening and closing the injection hole 111. The piston 13 reciprocally moves in accordance with the backpressure in the backpressure control chamber 21.

As shown in FIG. 1, the piston 13 is configured to slide up and down in a lower body 14 to move integrally with the nozzle needle 12. That is, as seen in FIG. 1, the nozzle needle 12 moves up when the piston 13 moves up, and the nozzle needle 12 moves down when the piston 13 moves down.

A fuel inflow passage 141 that is formed in the lower body 14 is supplied with high pressure fuel. When the nozzle needle 12 is at a high position to open the injection hole 111, the high pressure fuel flows from the fuel inflow passage 141 into a fuel passage 142 and a fuel accumulation chamber 112, and is injected out of the injection hole 111. The high pressure fuel supplied to the fuel inflow passage 141 also flows into a fuel passage 143 and the backpressure control chamber 21.

When the nozzle needle 12 is at a low position to close the injection hole 111, pressure in the fuel accumulation chamber 112 is high since the fuel accumulation chamber 112 is filled with the high pressure fuel flown from the fuel inflow passage 141. In contrast, the backpressure in the backpressure control chamber 21 is decreased by backpressure control operation of the solenoid valve 1, which is described below, even when the injection hole 111 is closed. Therefore, a difference between the pressure in the fuel accumulation chamber 112 and the pressure in the backpressure control chamber 21 moves up the nozzle needle 12 and the piston 13 integrally. Thereby, the injection hole 111 opens to inject high pressure fuel out of the injection hole 111.

When the backpressure in the backpressure control chamber 21 is increased by the backpressure control operation of the solenoid valve 1, the difference between the pressure in the fuel accumulation chamber 112 and the pressure in the backpressure control chamber 21 becomes zero. Therefore, the nozzle needle 12 moves down integrally with the piston 13, to close the injection hole 111. In this manner, the backpressure control operation by the solenoid valve 1 controls an open/close operation of the injection hole 111.

Next, the solenoid valve 1 will be described below, focusing attention on its construction for the backpressure control operation.

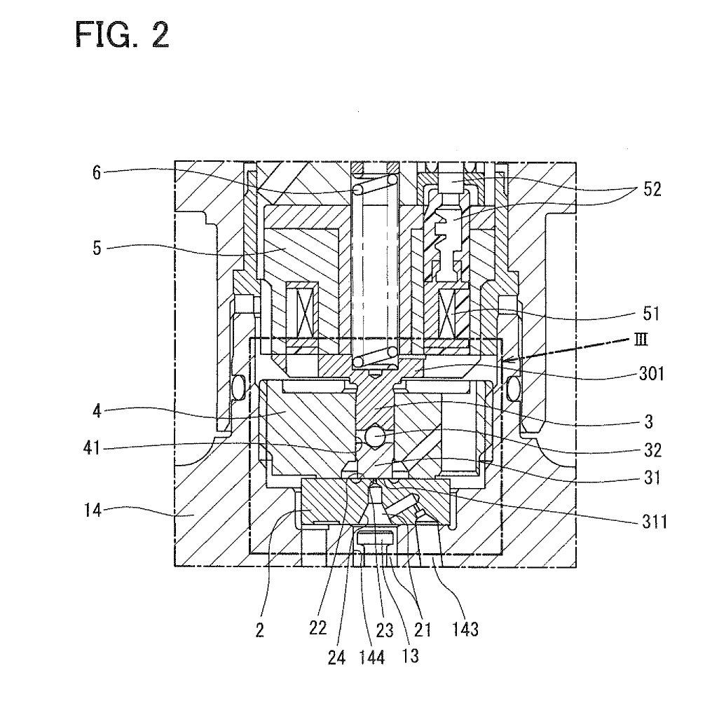

As shown in FIG. 2, the solenoid valve 1 has a plate 2, a valve body 4, an armature 3, a valve member 31 and a ball joint 32. The plate 2 has a valve hole 23 and a valve seat 22. The valve body 4 has a slide hole 41. The armature 3 is configured to slide reciprocally in the slide hole 41. The valve member 31 reciprocally slides in the slide hole 41 in association with the armature 3. The ball joint 32 is interposed between the armature 3 and the valve member 31.

The plate 2 is placed inside the lower body 14 and is fixed at a predetermined position with a dowel pin. The backpressure control chamber 21 is defined by an outer wall on an end portion of the piston 13, an inner wall 144 of the lower body 14 and an inner wall 24 of the plate 2.

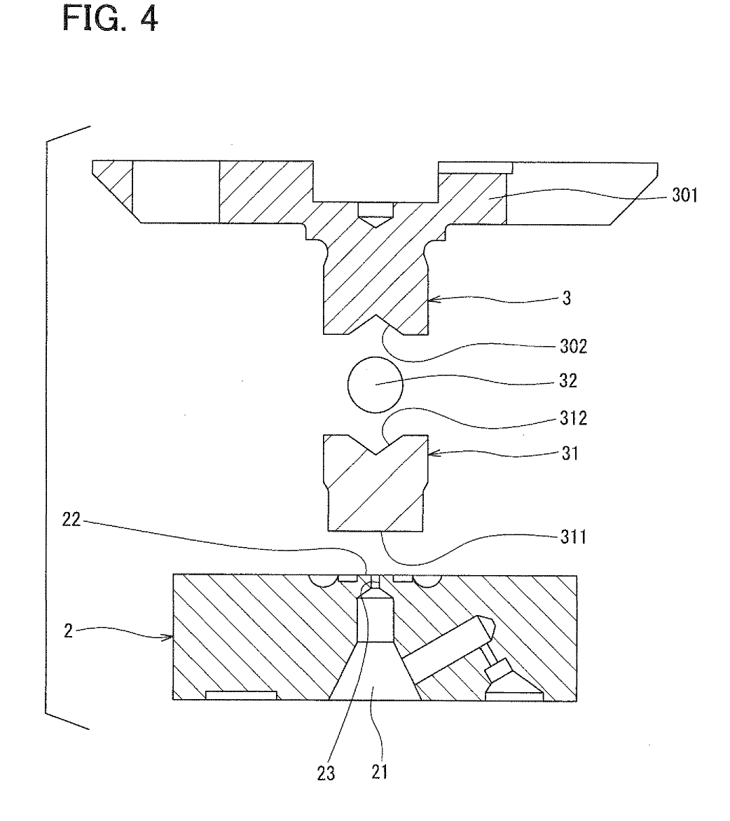

As shown in FIGS. 2-4, the valve member 31 is formed in an approximately cylindrical shape. The valve member 31 has a flat portion 311 and a slide surface 312 at both axial ends thereof. The flat portion 311 seats on or lifts off the valve seat 22 to close or open the valve hole 23. The slide surface 312 has a conically concave shape. The armature 3 has a wing portion 301 and a slide surface 302 on an opposite side from the wing portion 301. The wing portion 301 has an approximately disk-like shape. The slide surface 302 has a conically concave shape, and is opposed to the slide surface 312. The ball joint 32 has a spherical shape and is in sliding contact with the slide surfaces 302, 312, so that the armature 3 and the valve member 31 are slidably associated with each other.

The slide surfaces 302, 312 correspond to a connector or an engaging concave surface in the claims. The ball joint 32 corresponds to the connector or an engaging convex surface in the claims.

As shown in FIG. 2, the armature 3 is attracted to the stator 5 that is excited by an energized coil 51 while being urged toward the valve hole 23 by a spring 6. The coil 51 is energized via a terminal 52. When the coil 51 is not energized, the armature 3 is not attracted to the stator 5, so that the spring 6 urges the armature 3, the ball joint 32 and the valve member 31 toward the valve hole 23.

The flat portion 311 is subjected to the backpressure in the backpressure control chamber 21, which acts through the valve hole 23. Urging force of the spring 6 is determined so as to seat the flat portion 311 of the valve member 31 on the valve seat 22 against this backpressure. Thereby, when the coil 51 is not energized, the flat portion 311 is seated on the valve seat 22 and the valve hole 23 is closed, to keep the backpressure in the backpressure control chamber 21 at a large value.

In contrast, when the coil 51 is energized, the stator 5 is excited and attracts the armature 3. This attraction force between the stator 5 and the coil 51, and the urging force of the spring 6 are determined so that the attraction force of the stator 5 and the backpressure in the backpressure control chamber 21 would lift the flat portion 311 of the valve member 31 off the valve seat 22 against the urging force of the spring 6. Thereby, when the coil 51 is energized, the flat portion 311 of the valve member 31 is lifted off the valve seat 22 and the valve hole 23 is opened, to decrease the backpressure in the backpressure control chamber 21 to a small value.

The high pressure fuel flows into the backpressure control chamber 21 through the fuel passage 143 while the valve hole 23 is opened. An amount of fuel outflow from the valve hole 23 is set larger than an amount of fuel inflow into the backpressure control chamber 21. Therefore, if the electric power supply to the coil 51 is switched off, the flat portion 311 of the valve member 31 seats on the valve seat 22 to close the valve hole 23, even when the valve hole 23 is opened and the backpressure in the backpressure control chamber 21 is kept at a small value. Then, the high pressure fuel flows into the backpressure control chamber 21 through the fuel passage 143 to increase the backpressure in the backpressure control chamber 21 to a large value.

The backpressure in the backpressure control chamber 21 is controlled in this manner by switching on and off the electric power supply to the coil 51, to close or open the injection hole 111.

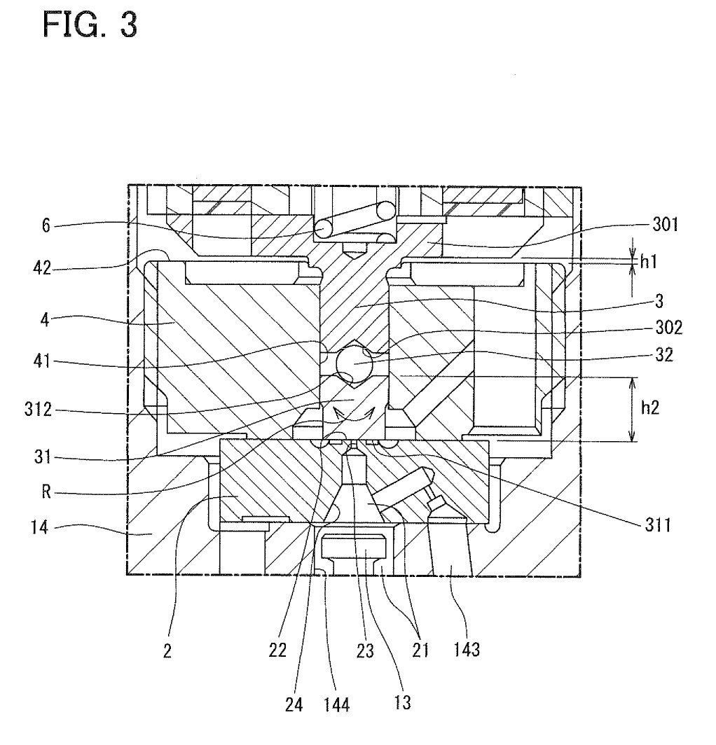

In the above construction, the valve member 31 reciprocally slides in the slide hole 41, and is supported by the slide hole 41 in such a manner that the valve member 31 does not rotate in a rotational direction R shown in FIG. 3. By the construction in which the slide hole 41 supports the valve member 31, the flat portion 311 of the valve member 31 does not become inclined with respect to the valve seat 22 even if the valve member 31 and the valve hole 23 become axially misaligned in a horizontal direction in FIG. 3. Specifically, if the valve member 31 and the valve hole 23 are axially misaligned in the horizontal direction in FIG. 3, the backpressure in the backpressure control chamber 21, i.e., the pressure of the high pressure fuel, which is applied through the valve hole 23, eccentrically acts on the flat portion 311 of the valve member 31. However, the valve member 31 is supported by the slide hole 41 in such a manner that the valve member 31 does not rotate. Thereby, the flat portion 311 of the valve member 31 does not become inclined with respect to the valve seat 22 even if the backpressure applied through the valve hole 23 eccentrically acts on the flat portion 311 of the valve member 31.

The armature 3 and the valve member 31 are slidably associated with each other, interposing the ball joint 32 therebetween. Specifically, the ball joint 32 can rotationally slide on the slide surface 302 of the armature 3 and on the slide surface 312 of the valve member 31. Therefore, although the armature 3 and the valve member 31 are slidably associated with each other, the flat portion 311 of the valve member 31 does not become inclined with respect to the valve seat 22 even if the valve member 31 and the valve hole 23 become axially misaligned.

Here, since the ball joint 32 is formed in a spherical shape, the ball joint 32 can be in smooth contact with the slide surfaces 302, 312. Furthermore, since the ball joint 32 is in contact with the slide surfaces 302, 312 that have conical shapes, a contact force between the ball joint 32 and the slide surface 302 or 312 is even over a circumference of a contact circle of the ball joint 32 and the slide surface 302 or 312. Therefore, slidabilities of the armature 3 and the valve member 31 are further improved.

The armature 3 and the valve member 31 are slidably associated with each other because the backpressure in the backpressure control chamber 21 must be controlled with high accuracy in order to control the fuel injection out of the injection hole 111 with high accuracy. Specifically, in order to control the backpressure with high accuracy, a dimensional tolerance required between the armature 3 and the valve body 4, which has the slide hole 41, and a dimensional tolerance required between the valve member 31 and the valve hole 23, which has the valve seat 22, are satisfied. Then, an association between the armature 3 and the valve member 31 absorbs a sum of these dimensional tolerances.

For example, a parallelism between an upper surface 42 of the valve body 4 and the wing portion 301 of the armature 3 is provided with a required dimensional tolerance. Then, the association between the armature 3 and the valve member 31 absorbs the sum of the dimensional tolerances.

A height of a gap h1 between the upper surface 42 of the valve body 4 and the wing portion 301 of the armature 3 is important for damping a bounce of the flat portion 311 of the valve member 31 when it is seating on the valve seat 22. The height of the gap h1 is adjusted by a height h2 of the valve member 31, which is measured in a sliding direction of the valve member 31. Specifically, two or more valve members 31 having the heights h2 that are different from each other are prepared, and one of the valve members 31 is selected, which has the height h2 that can realize a desirable height of the gap h1. Therefore, it is possible to adjust the height of the gap h1 by adjusting a dimension of the valve member 31, which has a cylindrical shape and has fine workability, handleability, etc. compared to a conventional valve member that has a spherical shape.

As described above, the fuel injector 10 that includes the solenoid valve 1 that can control the backpressure in the backpressure control chamber 21 with high accuracy can control the fuel injection out of the injection hole 111 with high accuracy.

### Modified Embodiments

It is possible to form the ball joint 32 in a shape of an elliptic ball. It is also possible to form the slide surfaces 302, 312 in a curved concave shape on which the ball joint 32 can rotationally slide.

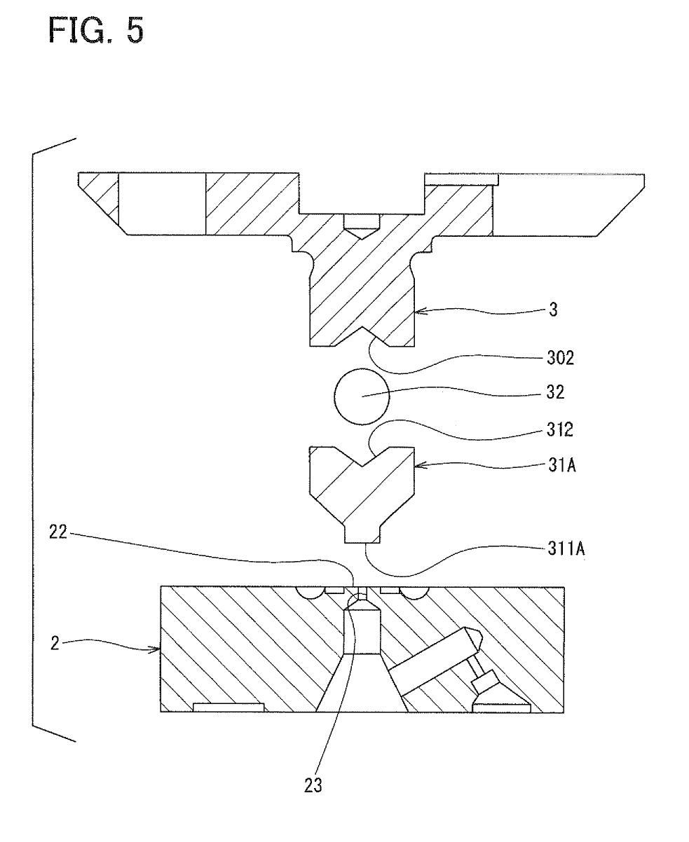

As shown in FIG. 5, it is possible to form a valve member 31A to have a flat portion 311A that is smaller than the flat portion 311 of the above-described valve member 31, provided the flat portion 311A can seat on or lift off from the valve seat 22 to close or open the valve hole 23.

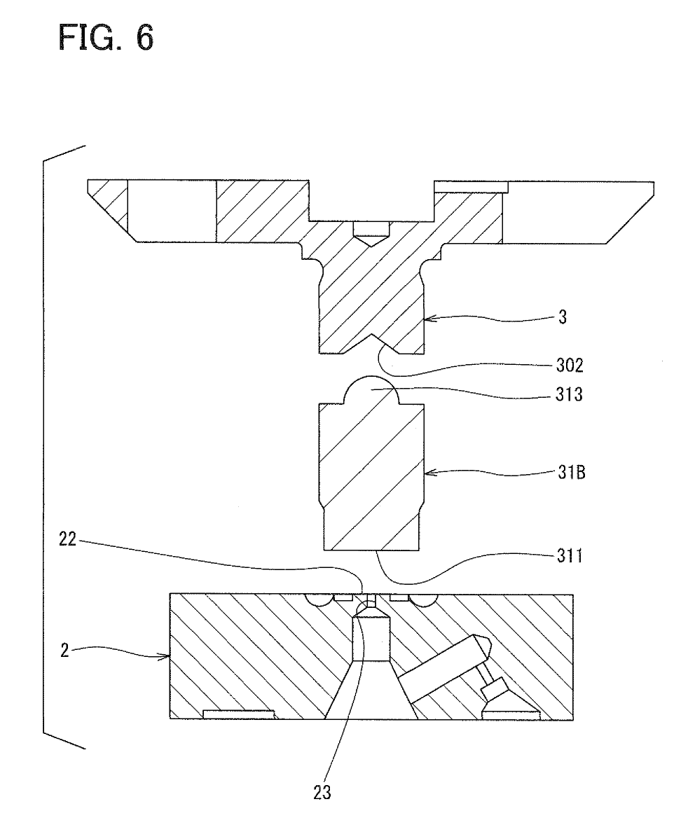

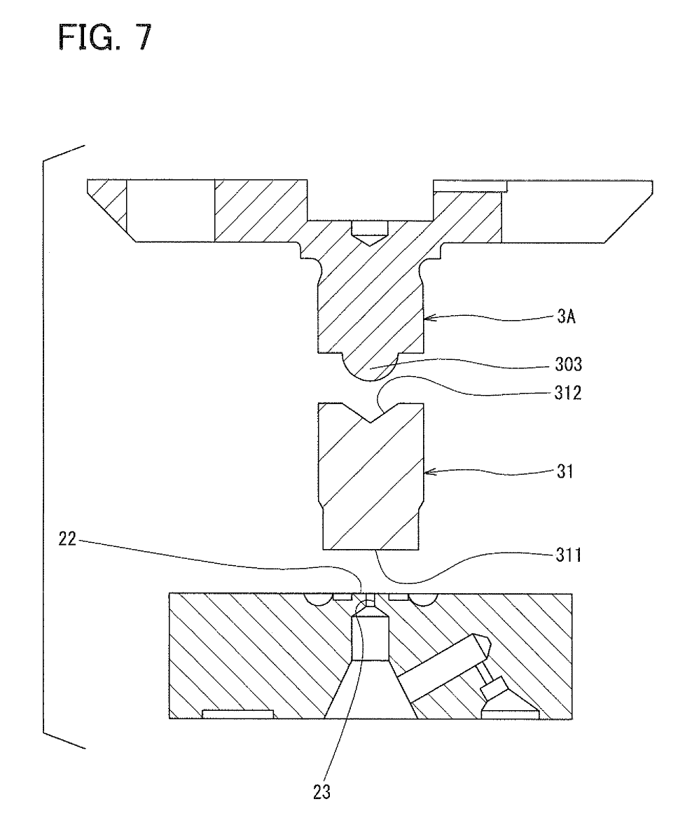

As shown in FIGS. 6 and 7, it is also possible to form one of the armature 3A and the valve member 31B integrally with the ball joint. Specifically, as shown in FIG. 6, it is possible to form the ball joint integrally with the valve member 31B to have a hemispherical convex portion 313 that is in sliding contact with the slide surface 302 of the armature 3. As shown in FIG. 7, it is also possible to form the ball joint integrally with the armature 3A to have a hemispherical convex portion 303 that is in sliding contact with the slide surface 312 of the valve member 31 In this manner, the armature 3 and the valve member 31 can be slidably associated with each other without employing an extra part (ball joint 32).

Additional advantages and modifications will readily occur to those skilled in the art. The invention in its broader terms is therefore not limited to the specific details, representative apparatus, and illustrative examples shown and described.

What is claimed is:

1. A solenoid valve comprising:
a valve body that has a slide hole that axially extends through the valve body;
an armature that is installed in the slide hole and is reciprocally slidable along an inner circumferential surface of the slide hole;
a valve seat that has a valve hole therein;
a valve member that is installed in the slide hole and is reciprocally slidable along the inner circumferential surface of the slide hole to seat on or lift off from the valve seat to close or open the valve hole, wherein one of the armature and the valve member includes an engaging concave surface; and
a connector that is formed separately from the armature and the valve member or is formed integrally with the other one of the armature and the valve member, wherein the connector includes an engaging convex surface that is in contact with the engaging concave surface of the one of the armature and the valve member.

2. The solenoid valve according to claim 1, wherein the connector is formed integrally with the other one of the armature and the valve member.

3. The solenoid valve according to claim 1, wherein:
the connector is formed separately from the armature and the valve member;
the connector has an approximately spherical shape or an approximately elliptically spherical shape;
the engaging convex surface that is in contact with the engaging concave surface of the one of the armature and the valve member is one side of the connector; and
the other one of the armature and the valve member has an engaging concave surface that is in contact with the other side of the connector.

4. The solenoid valve according to claim 2, wherein the engaging convex surface has an approximately hemispherical shape or an approximately elliptically hemispherical shape.

5. The solenoid valve according to claim 1, wherein the engaging concave surface of the one of the armature and the valve member has an approximately conical shape.

6. The solenoid valve according to any one of claim 3, wherein each of the engaging concave surface of the one of the armature and the valve member and the engaging concave surface of the other one of the armature and the valve member has an approximately conical shape.

7. A fuel injector comprising:
the solenoid valve according to claim 1;
a nozzle body that has an injection hole at a tip portion thereof;
a nozzle needle that is slidably installed in the nozzle body to open or close the injection hole; and
a piston that is slidably installed in the nozzle body to move integrally with the nozzle needle in accordance with a backpressure that is controlled by the solenoid valve.
